(19) United States
(12) Patent Application Publication
(10) Pub. No.: US 2026/0210402 A1
(43) Pub. Date: Jul. 23, 2026

(54) CAGE FOR CYLINDRICAL ROLLER BEARING

(71) Applicant: BEARING ART Corp., Gyeongju-si (KR)

(72) Inventors: KEUN PYO LEE, Seoul (KR); DU HAK HEO, Seoul (KR); SANG JUN LEE, Seoul (KR); WOON JU LEE, Seoul (KR)

(73) Assignee: BEARING ART Corp., Gyeongju-si (KR)

(21) Appl. No.: 19/440,658

(22) Filed: Jan. 6, 2026

(30) Foreign Application Priority Data
Jan. 17, 2025 (KR) 10-2025-0007567

(51) Int. Cl. F16C 33/46

(52) U.S. Cl. CPC F16C 33/467

(57) ABSTRACT

The cage includes: annular portions spaced apart in an axial direction; a plurality of column portions extending in the axial direction, having both ends connected to the annular portions, and spaced apart from each other in the circumferential direction; and a plurality of pockets 175, each defined by adjacent column portions and the annular portions on both sides, and arranged in the circumferential direction.

### CROSS-REFERENCE TO RELATED APPLICATION S

This application is based on and claims priority under 35 U.S.C. § 119 to Korean Patent Application No. 10-2025-0007567 filed on Jan. 17, 2025, in the Korean Intellectual Property Office, the disclosure of which is incorporated by reference herein in its entirety.

### BACKGROUND OF THE INVENTION

### Field of the Invention

The present invention relates to a cage for a cylindrical roller bearing, and more specifically, to a cage for a cylindrical roller bearing that improves oil lubricity, reduces oil stirring resistance, thereby reducing bearing friction torque.

### Background Art

Roller bearings vary greatly in type depending on the shape of the rollers. A ball bearing includes balls arranged between an inner ring and an outer ring, whereas a roller bearing includes rollers arranged between the inner ring and the outer ring. The roller bearing can withstand higher loads due to a larger contact area with the rollers compared to the ball bearing.

The simplest type of roller bearing is a cylindrical roller bearing, which has cylindrical rollers. The cylindrical roller bearing is mainly used when high radial load capacity is required and can also be used at relatively high speeds.

As illustrated in FIGS. 1 and 2, a general cylindrical roller bearing 10 includes: an inner ring 11 having an inner ring raceway 12 formed on the outer circumferential side in a ring shape; an outer ring 13 having a larger diameter than the inner ring 11, positioned outside the inner ring 11, and having an outer ring raceway 14 formed on the inner circumferential side; a plurality of cylindrical rollers 15 aligned in the circumferential direction between the inner ring raceway 12 and the outer ring raceway 14; and a cage 17 provided between the inner ring 11 and the outer ring 13 to maintain spacing between the rollers 15 on the circumference.

The cage 17 includes: a ring-shaped annular portion 17-1 spaced in the axial direction (perpendicular to the ground surface in FIG. 1); and a plurality of column portions 17-3 which extend in the axial direction and are spaced in the circumferential direction and of which both ends are connected to the annular portion 17-1. The cage 17 further includes a plurality of pockets, each defined by two adjacent column portions 17-3 and the annular portions 17-1 on both sides, and arranged in the circumferential direction to respectively accommodate rollers 15.

Both circumferential sides of each column portion 17-3 are provided with pocket surfaces 17-31 that form the pockets. As illustrated in FIG. 2, the pocket surfaces 17-31 face the outer circumferential side of the rollers 15 and are formed in a concave arc shape.

In the conventional cylindrical roller bearing 10 having the cage 17, there is a problem in that a flow direction of lubricant (oil) changes significantly during operation, and the lubricant (oil) does not flow actively through openings (A and B in FIG. 2) due to the pressure gradient between the rollers and the pocket surfaces.

### PATENT LITERATURE

### Patent Documents

Korean Patent Publication No. 10-2017-0071191

### SUMMARY OF THE INVENTION

Accordingly, the present invention has been made to solve the above-mentioned problems occurring in the prior arts, and it is an objective of the present invention to provide a cage for a cylindrical roller bearing that improves oil lubricity, reduces oil stirring resistance, thereby reducing bearing friction torque.

To accomplish the above object, according to the present invention, there is provided a cage for a cylindrical roller bearing, which includes: an inner ring having an inner ring raceway formed on an outer circumferential side thereof; an outer ring having a larger diameter than the inner ring and having an outer ring raceway formed on an inner circumferential side thereof; and a plurality of rollers arranged in a circumferential direction between the inner ring raceway and the outer ring raceway. The cage is provided between the inner ring and the outer ring and includes: annular portions spaced apart in an axial direction; a plurality of column portions extending in the axial direction, having both ends connected to the annular portions, and spaced apart from each other in the circumferential direction; and a plurality of pockets 175, each defined by adjacent column portions and the annular portions on both sides, and arranged in the circumferential direction, wherein each column portion includes pocket surfaces formed on both circumferential sides thereof, and each pocket surface includes: an outer inclined pocket surface formed to be inclined radially outward such that a distance from the opposing pocket surface of the adjacent column portion increases in the radially outward direction; an inner inclined pocket surface formed radially inward; and a concave pocket surface formed between the inner inclined pocket surface and the outer inclined pocket surface.

Moreover, the concave pocket surface includes at least one arcuate shape or at least one straight line shape.

Furthermore, an outer pocket surface is provided on a radially inner side of the outer pocket inclined surface with a different inclination angle, and a second protrusion protruding toward the roller is formed between the outer pocket inclined surface and the outer pocket surface, and an inner pocket surface inclined in an inclination direction of the outer pocket inclined surface is provided on a radially inner side of the outer pocket surface, such that the outer pocket surface and the inner pocket surface together form the concave pocket surface, wherein the inner pocket inclined surface is connected to the inner pocket surface and provided on a radially inner side of the inner pocket surface.

Additionally, the inner pocket surface is inclined such that a distance to a facing pocket surface of the adjacent column portion decreases in the radially inward direction, and the inner pocket inclined surface is formed at a different angle on a radially inner side of the inner pocket surface, such that a first protrusion protruding toward the roller is formed between the inner pocket inclined surface and the inner pocket surface.

In addition, a first angle between an extension line of the inner pocket surface and the inner pocket inclined surface is greater than 0° and less than 30°, and a second angle between an extension line of the outer pocket surface and the outer pocket inclined surface is greater than 0° and less than 60°.

Moreover, the first angle is smaller than the second angle.

Furthermore, the inner pocket inclined surface and the outer pocket surface are parallel to a radial line extending from a center of the roller to a center of the bearing.

Additionally, a distance between the inner pocket inclined surfaces at the facing pocket surfaces of the adjacent column portions is smaller than a distance between the outer pocket surfaces.

In addition, a width of the inner pocket inclined surface is greater than 0.05 times and less than 0.2 times a roller diameter.

Moreover, a pocket recess portion extending in a radial direction is formed on an inner side of the annular portion on both axial sides of the pocket surface.

According to the present invention, the cage for the cylindrical roller bearing is provided, in which a high pressure is maintained even when the opening between the roller and the pocket surface is enlarged, and a steep pressure gradient is formed between the roller and the pocket surface, thereby promoting the flow of lubricant (oil) through the opening and improving lubrication performance.

Moreover, since there is little change in the flow direction of the lubricant (oil) at the opening between the roller and the pocket surface, oil stirring resistance is reduced, and bearing friction torque is decreased, resulting in improved fuel efficiency or power efficiency when the bearing is assembled.

Furthermore, during the bearing manufacturing process, problems such as damage or warping of the cage due to interference between an injection mold and the cage can be prevented, thereby improving productivity.

### BRIEF DESCRIPTION OF THE DRAWINGS

FIG. 1 is a front view illustrating a conventional cylindrical roller bearing.

FIG. 2 is a partial cross-sectional view taken along an axial middle portion of section “A” in FIG. 1.

FIG. 3 is a perspective view and a partially enlarged view of a cage for a cylindrical roller bearing according to the present invention.

FIG. 4 is a cross-sectional view corresponding to FIG. 2, showing a cylindrical roller bearing provided with the cage of the present invention.

FIGS. 5 and 6 are partial cross-sectional views and enlarged views illustrating specific forms of the cage for a cylindrical roller bearing according to the present invention, shown together with rollers.

FIG. 7 is a simulation result comparing oil flow during operation between the conventional cylindrical roller bearing and the cylindrical roller bearing provided with the cage of the present invention.

FIG. 8 is a simulation result comparing oil pressure distribution during operation between the conventional cylindrical roller bearing and the cylindrical roller bearing provided with the cage of the present invention.

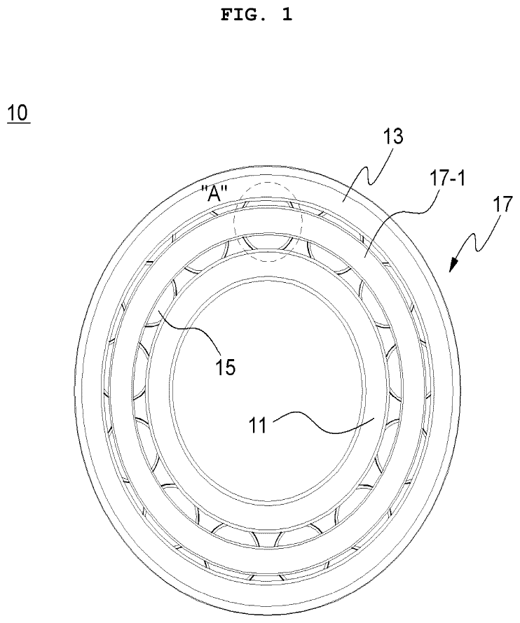

### DETAILED DESCRIPTION OF THE PREFERRED EMBODIMENT

All technical and scientific terms used in the present specification, unless otherwise defined, have the same meaning as commonly understood by those of ordinary skill in the art to which the present invention belongs. The terms used herein are selected to best describe the present invention and are not intended to limit the scope of the present invention.

The expressions such as “include,” “comprise,” or “have” used in the present specification should be interpreted as open-ended terms that allow the inclusion of other components, unless explicitly stated otherwise.

The singular forms used in the present invention may also include plural forms unless the context clearly indicates otherwise. The above applies equally to the expressions used in the claims.

The terms “first,” “second,” and the like used in the specification are intended only to distinguish between multiple elements, and do not imply any particular order or importance.

When a component is described as being “connected to” or “coupled to” another component, it is to be understood that the component may be directly connected or coupled to the other component or may be indirectly connected or coupled through another component.

Hereinafter, with reference to the accompanying drawings, a cylindrical roller bearing and a cage for the cylindrical roller bearing according to the present invention will now be described in detail.

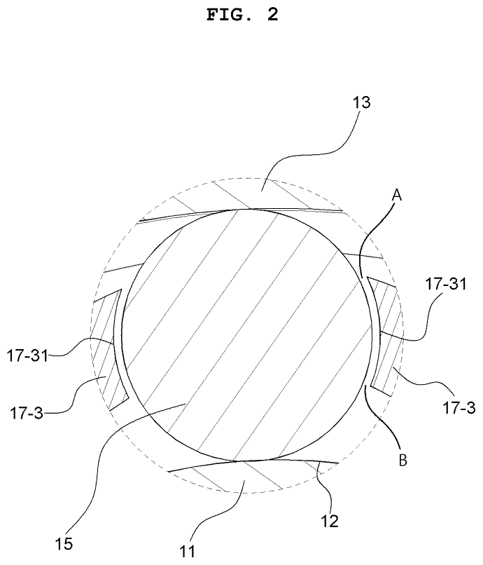

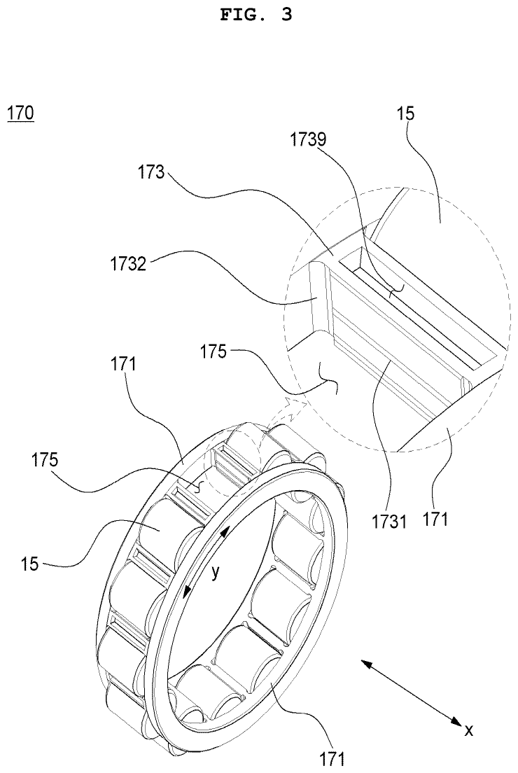

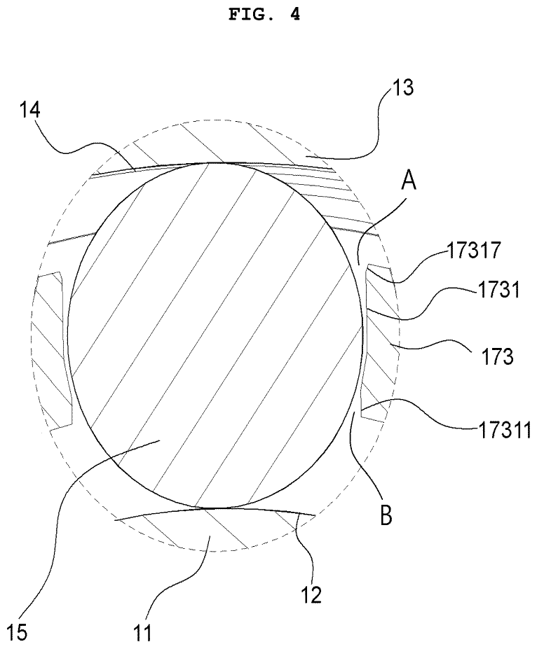

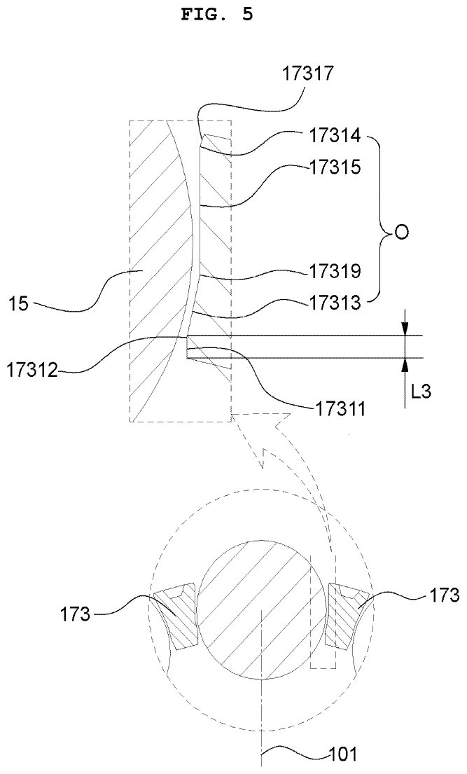

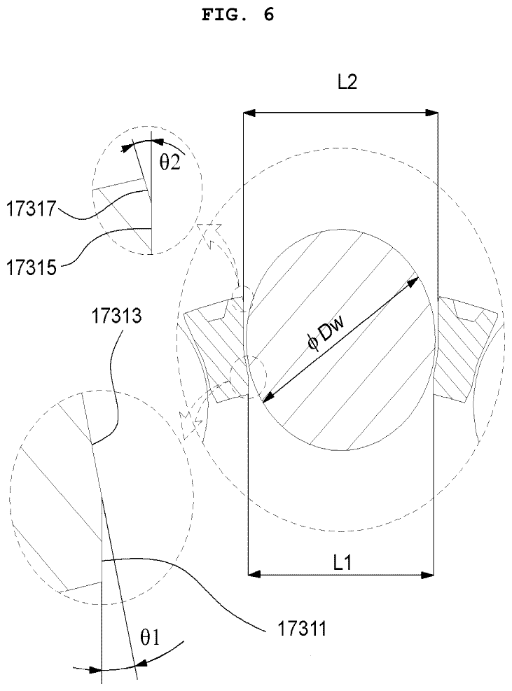

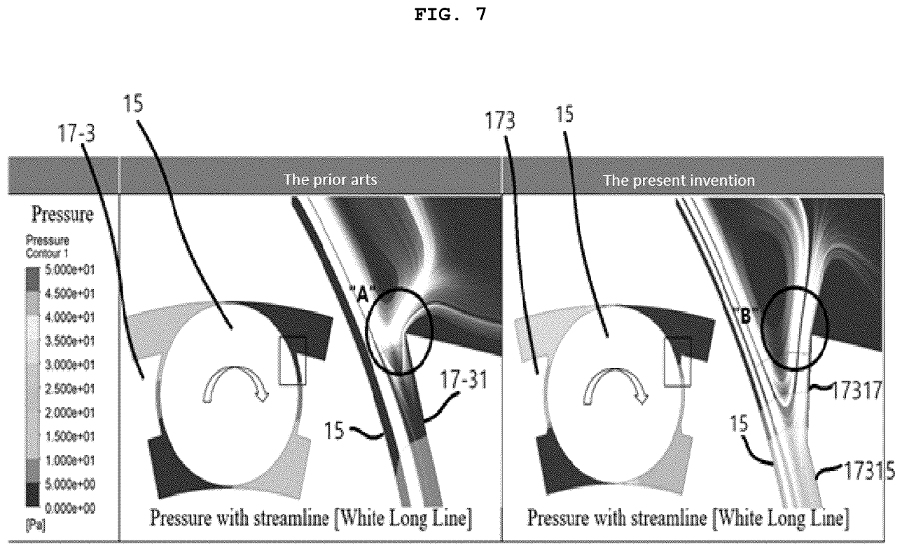

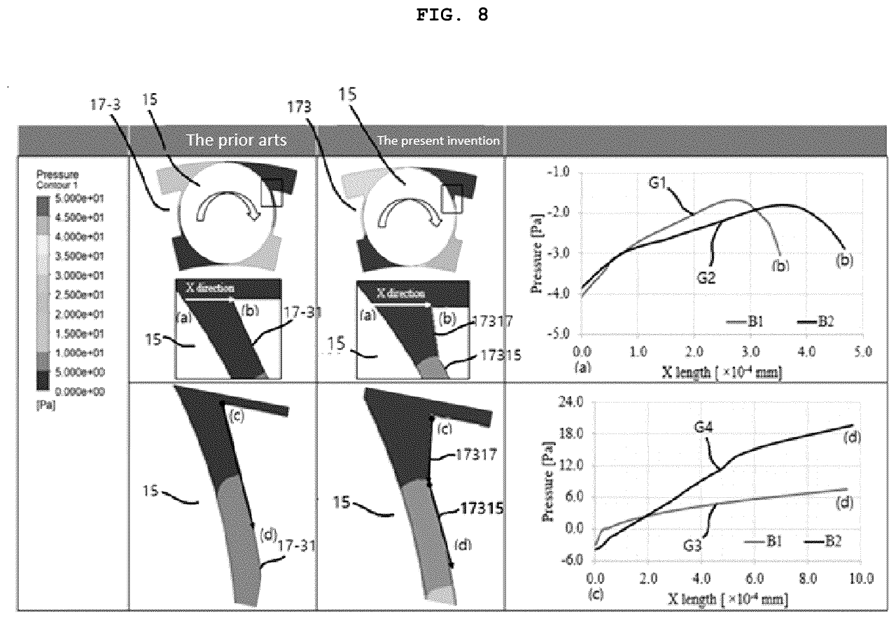

FIG. 3 is a perspective view and a partially enlarged view of a cage for a cylindrical roller bearing according to the present invention, FIG. 4 is a cross-sectional view corresponding to FIG. 2, showing a cylindrical roller bearing provided with the cage of the present invention, FIGS. 5 and 6 are partial cross-sectional views and enlarged views illustrating specific forms of the cage for a cylindrical roller bearing according to the present invention, shown together with rollers, FIG. 7 is a simulation result comparing oil flow during operation between the conventional cylindrical roller bearing and the cylindrical roller bearing provided with the cage of the present invention, and FIG. 8 is a simulation result comparing oil pressure distribution during operation between the conventional cylindrical roller bearing and the cylindrical roller bearing provided with the cage of the present invention.

First, regarding directions, the x-direction in FIG. 3 is the axial direction, and the y-direction in FIG. 4 is the circumferential direction.

The cylindrical roller bearing equipped with the cage 170 according to the present invention includes an inner ring 11 and an outer ring 13. An inner ring raceway 12 is formed on the outer circumferential side of the inner ring 11. An outer ring raceway 14 is formed on the inner circumferential side of the outer ring 13, which has a larger diameter than the inner ring 11. A plurality of rollers 15 are arranged in the circumferential direction between the inner ring raceway 12 and the outer ring raceway 14. The cage 170 of the present invention is provided between the inner ring 11 and the outer ring 13 of the cylindrical roller bearing.

The cage 170 includes annular portions 171 and a plurality of column portions 173. The annular portions 171 are formed in the shape of rings spaced apart in the axial direction. The column portions 173 extend in the axial direction, with both ends connected to the annular portions 171 and spaced apart from each other in the circumferential direction. The cage 170 further includes a plurality of pockets 175, each defined by two adjacent column portions 173 and the annular portions 171 on both sides, and arranged in the circumferential direction.

In this instance, both circumferential sides of each column portion 173 are provided with pocket surfaces 1731 that form the pockets 175. Each pocket surface 1731 includes an outer inclined pocket surface 17317 and an inner inclined pocket surface 17311. The outer inclined pocket surface 17317 is formed to be inclined radially outward such that a distance from the opposing pocket surface 1731 of the adjacent column portion 173 increases in the radially outward direction. The inner inclined pocket surface 17311 is formed radially inward from the outer inclined pocket surface 17317. A concave pocket surface O is formed between the inner and outer inclined pocket surfaces 17311 and 17317. In this instance, the concave pocket surface O may include at least one arcuate shape or at least one linear shape.

On the radially inner side of the outer inclined pocket surface 17317, an outer pocket surface 17315 is formed at a different angle. A second protrusion 17314 protruding toward the roller 15 is formed between the outer inclined pocket surface 17317 and the outer pocket surface 17315. On the radially inner side of the outer pocket surface 17315, an inner pocket surface 17313 inclined in the same direction as the outer inclined pocket surface 17317 is formed. The outer pocket surface 17315 and the inner pocket surface 17313 together form the concave pocket surface O. The inner inclined pocket surface 17311 is connected to the inner pocket surface 17313 and is positioned radially inward of the inner pocket surface 17313.

The inner pocket surface 17313 is inclined such that the distance from the opposing pocket surface 1731 of the adjacent column portion 173 decreases in the radially inward direction. Additionally, the inner inclined pocket surface 17311 is formed at a different angle on the radially inner side of the inner pocket surface 17313. A first protrusion 17312 protruding toward the roller 15 is formed between the inner inclined pocket surface 17311 and the inner pocket surface 17313.

In this instance, the inner pocket surface 17313 and the outer pocket surface 17315 may be directly connected, or a curved concave central surface 17319 may be further provided therebetween.

According to the present invention, the inner inclined pocket surface 17311, the inner pocket surface 17313, the outer pocket surface 17315, and the outer inclined pocket surface 17317 are each formed at different angles.

In this instance, the inner inclined pocket surface 17311 and the outer inclined pocket surface 17317 form openings (A and B in FIG. 4) expanded radially with respect to the roller 15, and the inner pocket surface 17313 and the outer pocket surface 17315 form concave pocket surfaces O inside the openings.

As illustrated in FIG. 8, when the bearing equipped with the cage according to the present invention rotates, although the opening is enlarged by the outer inclined pocket surface 17317, the simulation results show that an oil pressure (G2) at the opening formed between the roller 15 and the cage 170 reaches the same peak pressure value (G1) as that of the conventional cage (see upper right graph in FIG. 8).

Accordingly, it was confirmed that more oil flowed through the opening, namely, an area between (a) and (b), thereby improving lubricity.

When examining the pressure gradient at the opening formed between the roller 15 and the cage 170 and between the inner pocket surface and the roller, it can be seen from the simulation result on the left side of FIG. 8 and the lower right graph in FIG. 8 that, while the pressure at position (c), i.e., the opening, was approximately the same negative pressure value (G3, G4) in both the conventional art and the present invention, the pressure at position (d) in the bearing equipped with the cage of the present invention was 19 Pa and the pressure at position (d) in the bearing equipped with the conventional cage was 7 Pa. Thus, it was confirmed that the pressure at position (d) in the bearing equipped with the cage of the present invention was more than twice as high. Therefore, since the pressure gradient is steeper in the bearing equipped with the cage of the present invention, a larger amount of oil flows through the opening, namely, the area between (a) and (b), resulting in improved lubrication performance.

Meanwhile, FIG. 7 shows simulation results comparing the left portion “A,” which represents the bearing assembled with the conventional cage, and the right portion “B,” which represents the bearing assembled with the cage of the present invention. It was confirmed that in the bearing with the conventional cage, the change in the oil flow direction is significantly more severe.

Furthermore, according to the cage 170 of the present invention, the inner inclined pocket surface 17311 and the outer inclined pocket surface 17317 are provided in the radial inward and outward directions, respectively. As oil flows between the cage 170 and the roller 15, the change in the oil flow direction is reduced, thereby decreasing oil stirring resistance and reducing the friction torque of the bearing. As a result, fuel efficiency or electric efficiency can be improved when the bearing is assembled.

In this case, a first angle θ1 between an extension line of the inner pocket surface 17313 and the inner inclined pocket surface 17311 is preferably greater than 0° and less than 30°, and a second angle θ2 between an extension line of the outer pocket surface 17315 and the outer inclined pocket surface 17317 is preferably greater than 0° and less than 60°. This is because when the first angle θ1 is in the range of 0° to 30° and the second angle θ2 is in the range of 0° to 60°, the oil flow rate increases and lubricity improves. If the first angle θ1 exceeds the 0°-30° range, interference occurs between an injection mold and the column portion, degrading moldability. If the second angle θ2 exceeds the 0°-60°range, the rigidity of the column portion is reduced due to the decreased wall thickness, making it difficult to properly support the rolling of the roller.

In particular, it is preferable that the first angle θ1 is smaller than the second angle θ2. This is because, as confirmed in FIGS. 7 and 8, the effects described above are achieved when the first angle θ1 is smaller than the second angle θ2.

Meanwhile, the inner inclined pocket surface 17311 and the outer pocket surface 17315 may be formed parallel to a radial line 101 extending from the center of the roller 150 to the center of the bearing. In this case, the inner inclined pocket surfaces 17311 may be parallel to each other, and the outer pocket surfaces 17315 may also be formed parallel to each other.

The inner ring 11 and the outer ring 13 are provided concentrically, and the center of the bearing is defined by the center of the inner ring 11. In this case, the inner inclined pocket surfaces 17311 in the opposing pocket surfaces 1731 of adjacent column portions 173 are parallel to each other, and the outer pocket surfaces 17315 are also formed parallel to each other.

With the above configuration, since the inner inclined pocket surfaces 17311 and the outer pocket surfaces 17315 are aligned with the radial line 101, oil flow resistance is reduced and oil flow is smoothed, resulting in improved lubricity.

In addition, it is preferable that a distance (L1) between the inner inclined pocket surfaces 17311 in the opposing pocket surfaces 1731 of adjacent column portions 173 is smaller than a distance (L2) between the outer pocket surfaces 17315. Accordingly, oil flow resistance is reduced, and smooth flow is achieved, thereby improving lubricity.

It is also preferable that a width (L3) of the inner inclined pocket surface 17311 is greater than 0.05 times a roller diameter (Dw) and smaller than 0.2 times the roller diameter (Dw). This is because, if the width (L3) of the inner inclined pocket surface 17311 is smaller than 0.05 times the roller diameter (Dw), it fails to provide effective flow guidance. Conversely, if the width (L3) exceeds 0.2 times the roller diameter (Dw), the cage cannot properly support the rolling motion of the rollers. Meanwhile, as illustrated in FIG. 5, the width (L3) of the inner inclined pocket surface 17311 is measured along the radial line 101.

This is because, if the width (L3) of the inner inclined pocket surface 17311 is less than 0.05 times the roller diameter (Dw), the flow guiding effect is not realized, and if the width (L3) exceeds 0.2 times the roller diameter (Dw), the cage fails to smoothly support the rolling of the rollers.

Additionally, on both axial sides of the pocket surface 1731, pocket recess portions 1732 extending in the radial direction may be formed inside the annular portion 171. Due to the pocket recess portions 1732, the rigidity of the cage increases, and oil discharge from both axial sides of the rollers 150 becomes smoother, thereby enhancing lubricity and reducing flow resistance caused by the oil.

What is claimed is:

1. A cage for a cylindrical roller bearing, the bearing comprising: an inner ring having an inner ring raceway formed on an outer circumferential side thereof; an outer ring having a larger diameter than the inner ring and having an outer ring raceway formed on an inner circumferential side thereof; and a plurality of rollers arranged in a circumferential direction between the inner ring raceway and the outer ring raceway,
wherein the cage is provided between the inner ring and the outer ring and comprises:
annular portions spaced apart in an axial direction; a plurality of column portions extending in the axial direction, having both ends connected to the annular portions, and spaced apart from each other in the circumferential direction; and a plurality of pockets 175, each defined by adjacent column portions and the annular portions on both sides, and arranged in the circumferential direction,
wherein each column portion includes pocket surfaces formed on both circumferential sides thereof, and
wherein each pocket surface includes:
an outer inclined pocket surface formed to be inclined radially outward such that a distance from the opposing pocket surface of the adjacent column portion increases in the radially outward direction; an inner inclined pocket surface formed radially inward; and a concave pocket surface formed between the inner inclined pocket surface and the outer inclined pocket surface.

2. The cage according to claim 1, wherein the concave pocket surface includes at least one arcuate shape or at least one straight line shape.

3. The cage according to claim 1, wherein an outer pocket surface is provided on a radially inner side of the outer pocket inclined surface with a different inclination angle, and a second protrusion protruding toward the roller is formed between the outer pocket inclined surface and the outer pocket surface, and an inner pocket surface inclined in an inclination direction of the outer pocket inclined surface is provided on a radially inner side of the outer pocket surface, such that the outer pocket surface and the inner pocket surface together form the concave pocket surface, wherein the inner pocket inclined surface is connected to the inner pocket surface and provided on a radially inner side of the inner pocket surface.

4. The cage according to claim 3, wherein the inner pocket surface is inclined such that a distance to a facing pocket surface of the adjacent column portion decreases in the radially inward direction, and the inner pocket inclined surface is formed at a different angle on a radially inner side of the inner pocket surface, such that a first protrusion protruding toward the roller is formed between the inner pocket inclined surface and the inner pocket surface.

5. The cage according to claim 4, wherein a first angle between an extension line of the inner pocket surface and the inner pocket inclined surface is greater than 0° and less than 30°, and a second angle between an extension line of the outer pocket surface and the outer pocket inclined surface is greater than 0° and less than 60°.

6. The cage according to claim 5, wherein the first angle is smaller than the second angle.

7. The cage according to claim 3, wherein the inner pocket inclined surface and the outer pocket surface are parallel to a radial line extending from a center of the roller to a center of the bearing.

8. The cage according to claim 4, wherein the inner pocket inclined surface and the outer pocket surface are parallel to a radial line extending from a center of the roller to a center of the bearing.

9. The cage according to claim 5, wherein the inner pocket inclined surface and the outer pocket surface are parallel to a radial line extending from a center of the roller to a center of the bearing.

10. The cage according to claim 7, wherein a distance between the inner pocket inclined surfaces at the facing pocket surfaces of the adjacent column portions is smaller than a distance between the outer pocket surfaces.

11. The cage according to claim 4, wherein a width of the inner pocket inclined surface is greater than 0.05 times and less than 0.2 times a roller diameter.

12. The cage according to claim 5, wherein a width of the inner pocket inclined surface is greater than 0.05 times and less than 0.2 times a roller diameter.

13. The cage according to claim 6, wherein a width of the inner pocket inclined surface is greater than 0.05 times and less than 0.2 times a roller diameter.

14. The cage according to claim 4, wherein a pocket recess portion extending in a radial direction is formed on an inner side of the annular portion on both axial sides of the pocket surface.

15. The cage according to claim 5, wherein a pocket recess portion extending in a radial direction is formed on an inner side of the annular portion on both axial sides of the pocket surface.

16. The cage according to claim 6, wherein a pocket recess portion extending in a radial direction is formed on an inner side of the annular portion on both axial sides of the pocket surface.
